(19) United States
(12) Patent Application Publication
(10) Pub. No.: US 2009/0319506 A1
(43) Pub. Date: Dec. 24, 2009

(54) SYSTEM AND METHOD FOR EFFICIENTLY FINDING EMAIL SIMILARITY IN AN EMAIL REPOSITORY

(76) Inventor: Tsuen Wan Ngan, Los Angeles, CA (US)

Correspondence Address: Meyertons, Hood, Kivlin, Kowert, Goetzel/Symantec, P.O. Box 398, Austin, TX, 78767-0398, US

(21) Appl. No.: 12/142,546

(22) Filed: Jun. 19, 2008

(51) Int. Cl. G06F 17/30; G06F 7/06

(52) U.S. Cl. 707/5; 707/E17.069

(57) ABSTRACT

Systems and methods for efficiently identifying emails with content similarity are disclosed. In one embodiment, a method comprises grouping a first set of a plurality of email documents with only common-type subsets of character sequences in a first searchable group, and grouping a second set of the plurality of email documents with one or more uncommon-type subsets of character sequences in a second searchable group. The method further comprises selectively searching either only one of or both of the first and second searchable groups, and identifying selected one or more email documents of the plurality of email documents that may contain content that is similar to the particular email document based on the searching.

### BACKGROUND OF THE INVENTION

1. Field of the Invention

This invention relates to email systems, and more particularly to the detection of content containment within email documents.

2. Description of the Related Art

Frequently, it is desired to efficiently find similar emails located in a database. For example, in litigation e-discovery situations, extensive databases of emails must be searched to decide whether emails are important to a legal case. Searching through an extensive database and comparing emails to determine potentially similar ones can be a problematic and tedious process. One approach for comparing emails for similarity is to compute a hash value from the content of differing emails and then compare the hash values for equality. Unfortunately, such approaches would typically only identify emails that are exact duplicates, since any differences in the emails would typically result in the generation of different hash values. Another possible approach is to compare every word of an email against the words of another to determine similarity. However, such an approach is typically very computationally intensive.

Often, emails may contain similar content because an email is forwarded or replied to. When an initial email is repetitively replied to and/or forwarded, it may be desirable to find only the last email in the chain, since the last email often contains all of the content of the preceding emails. Thus, in e-discovery situations, it may be more desirable to find a last email in a chain of responsive emails so that a minimum number of emails can be reviewed without missing any information.

### SUMMARY

Systems and methods for efficiently identifying emails with content similarity are disclosed. In one embodiment, a method comprises identifying, for each email document of a plurality of email documents, whether each subset of one or more subsets of character sequences within the email document is a common-type subset of character sequences or an uncommon-type subset of character sequences. The method further comprises grouping a first set of the plurality of email documents with only common-type subsets of character sequences in a first searchable group, and grouping a second set of the plurality of email documents with one or more uncommon-type subsets of character sequences in a second searchable group. The method additionally comprises identifying whether each subset of character sequences in a particular email document to be evaluated is a common-type or an uncommon-type subset of character sequences, and selectively searching either only one of or both of the first and second searchable groups depending upon whether the particular email contains only common-type subsets of character sequences, only uncommon-type subsets of character sequences, or a combination of common-type and uncommon-type subsets of character sequences. The method also comprises identifying selected one or more email documents of the plurality of email documents that may contain content that is similar to the particular email document based on the searching.

In some embodiments, each subset of character sequences is a paragraph. In one embodiment, the searching is both the first and second searchable groups if the particular email document contains only common-type subsets of character sequences, and the searching is only the second searchable group if the particular email document contains only uncommon-type subsets of character sequences or a combination of common-type and uncommon-type subsets of character sequences. In another embodiment, the searching is only the first searchable group if the particular email document contains only common-type subsets of character sequences, the searching is only the second searchable group if the particular email document contains only uncommon-type subsets of character sequences, and the searching is both the first and second group if the particular email contains a combination of common-type and uncommon-type subsets of character sequences.

### BRIEF DESCRIPTION OF THE DRAWINGS

FIG. 1 is a block diagram of a computer system including an email database and containment detection code.

FIG. 2 is a flowchart of one embodiment of a method to group sets of email documents into searchable groups.

FIG. 3 depicts content of two exemplary emails.

FIG. 4 depicts an exemplary hash.

FIG. 5 depicts two exemplary data structures representative of two searchable groups.

FIG. 6 is a flowchart of one embodiment of a method to identify email documents that may contain content of a particular email document.

FIGS. 7 A-C depict exemplary applications of the flowchart of FIG. 6.

FIG. 8 is a flowchart of one embodiment of a method to identify email documents that have content contained within a particular email document.

FIGS. 9 A-C depict exemplary applications of the flowchart of FIG. 8.

FIG. 10 is a flowchart of one embodiment of a method for comparing hash values using bloom-filtering techniques.

FIG. 11 is an exemplary identified email document with an exemplary hash.

FIG. 12 depicts exemplary bloom filters.

FIG. 13 depicts an exemplary bitwise OR comparison of bloom filters.

While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents, and alternatives falling within the spirit and scope of the present invention as defined by the appended claims. It is noted that the word “may” is used throughout this application in a permissive sense (i.e., having the potential to, being able to), not a mandatory sense (i.e., must).

### DETAILED DESCRIPTION

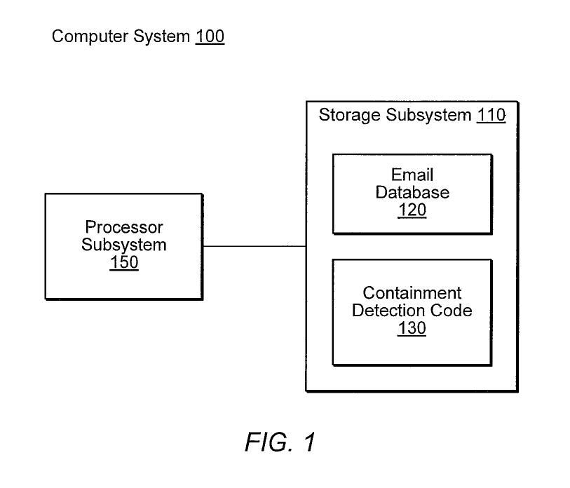

Turning now to FIG. 1, a block diagram of one embodiment of a computer system 100 is shown. Computer system 100 includes a storage subsystem 110 coupled to a processor subsystem 150. Storage subsystem 110 is shown storing an email database 120 and containment detection code 130. Computer system 100 may be any of various types of devices, including, but not limited to, a personal computer system, desktop computer, laptop or notebook computer, mainframe computer system, handheld computer, workstation, network computer, a consumer device such as a mobile phone, pager, or personal data assistant (PDA). Computer system 100 may also be any type of networked peripheral device such as storage devices, switches, modems, routers, etc. Although a single computer system 100 is shown in FIG. 1, system 100 may also be implemented as two or more computer systems operating together.

Processor subsystem 150 is representative of one or more processors capable of executing containment detection code 130. Various specific types of processors may be employed, such as, for example, an x86 processor, a Power PC processor, an IBM Cell processor, or an ARM processor.

Storage subsystem 110 is representative of various types of storage media, also referred to as “computer readable storage media.” Storage subsystem 110 may be implemented using any suitable media type and/or storage architecture. For example, storage subsystem 110 may be implemented using storage media such as hard disk storage, floppy disk storage, removable disk storage, flash memory, semiconductor memory such as random access memory or read only memory, etc. It is noted that storage subsystem 110 may be implemented at a single location or may be distributed (e.g., in a SAN configuration).

Email database 120 contains a plurality of email messages, each referred to herein as an email document, associated with one or more email system users. It is noted that various email documents within email database 120 may be duplicates of one another or may contain substantially similar content to that of other emails in the database (e.g., an initial email and a corresponding response email containing the initial email).

As will be described in further detail below, containment detection code 130 includes instructions executable by processor subsystem 150 to identify whether content of one email document in database 120 is contained (or potentially contained) within another email document. In various embodiments, email documents identified by containment detection code 130 as potentially being contained or containing the content of other emails may be reported to a user (e.g., a last email in a chain of responsive emails). Execution of containment detection code 130 may allow efficient filtering of email documents that do not contain content that is substantially similar to that of other email documents. Containment detection code 130 may analyze previously received email documents that are already in database 120, or it may analyze email documents as they are received in real time and compare them with existing email documents in database 120. In some embodiments, identified emails may be further evaluated. For example, upon identification, email documents may be analyzed or compared by additional code to determine and/or verify the extent to which content of one email is contained within another, and/or to identify chains of emails.

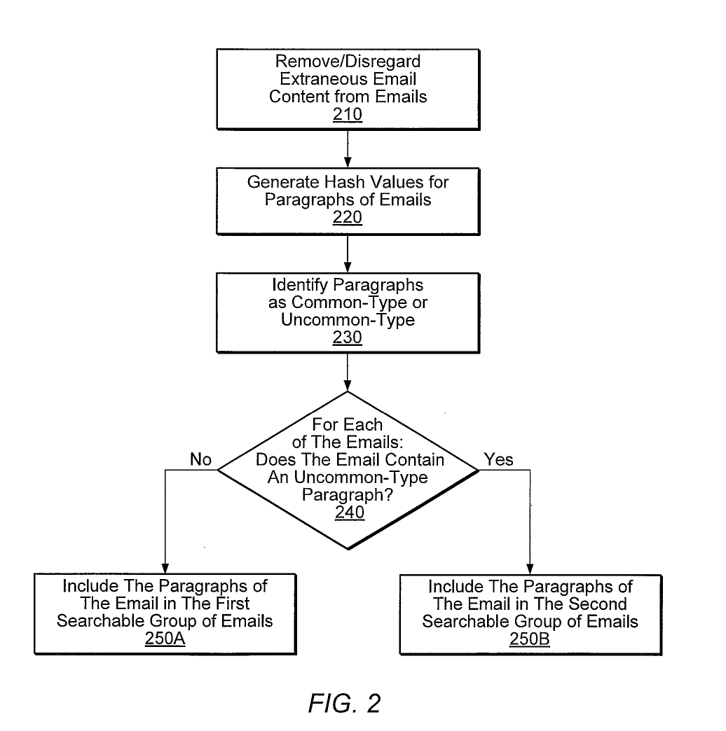

In order to identify whether content of one email document is contained within another email document, containment detection code 130 may group sets of email documents in database 120 into searchable groups that are searched to identify potential emails that may contain content that is similar to other email documents. FIG. 2 is one embodiment of a flow diagram that generates searchable groups from email documents contained in database 120. While the operations of FIG. 2 are shown in a particular order, certain operations may be performed in parallel or in various other orders. For example, steps 220 and steps 230 may be performed in parallel or in a different order than illustrated.

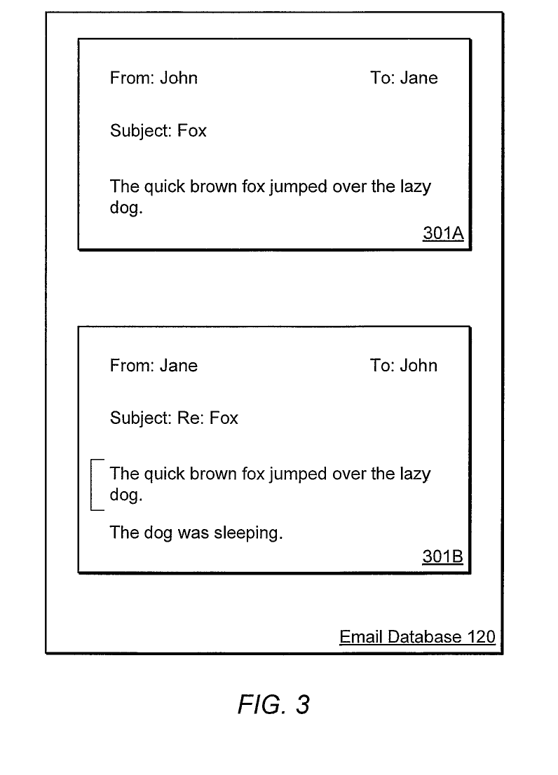

Operations illustrated in FIG. 2 will be discussed in conjunction with an exemplary situation illustrated by FIG. 3, which shows content of two possible email documents 301A and 301B. As shown, email documents 301A and 301B are contained within email database 120. Email document 301B represents a possible response to email document 301A. In this example, the email documents 301A and 301B contain different email headers (e.g., the From, To, and Subject portions), and email document 301B contains the sequence “The dog was sleeping”, which is not included in email document 301A.

In step 210, extraneous email content in an email document being processed is removed or disregarded. This extraneous content may include common, reoccurring phrases found in typical email documents such as, “From [Name], To [Name], Subject [TITLE], On [DATE], at [TIME], [NAME] wrote:”, “Begin forwarded message:”, “-----Original Message-----”, etc. In this example, the “From [Name]”, “To [Name]”, and “Subject [TITLE]” portions of the header are removed before proceeding to step 220, described below. In various embodiments, the extraneous email content removed/disregarded from each email document during step 210 may be predetermined or pre-selected words or phrases (e.g., phrases generally common to email documents). In other embodiments, the extraneous email content that is removed/disregarded may be controlled or specified by input from a user. It is noted that in some embodiments step 210 may be omitted.

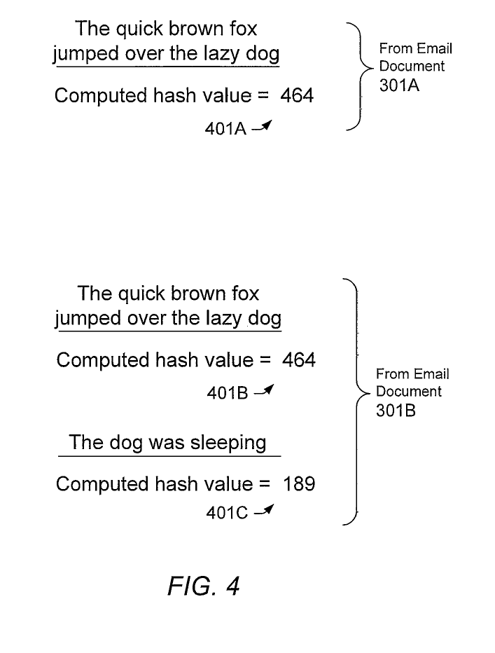

In step 220, sets of hash values are generated from the remaining content (following step 210) of each email in email database 120. In one embodiment shown in FIG. 4, a hash value (e.g., hash values 401A-401C) is generated for each paragraph of a respective email 301A and 301B. In this particular embodiment, the alphabetic positions of each character in a paragraph are summed to generate each hash value. For example, the character “T” is the 20^{th} letter in the alphabet and the character “h” is the 8^{th} letter. Thus, a hash value of “464” is generated based on the sum of the alphabetic positions of the characters in the paragraph “The quick brown fox jumped over the lazy dog.” The hash value “189” is similarly calculated based on the respective paragraph “The dog was sleeping”.

It is noted that any of a variety of other hash functions may be used to compute the hash value for a particular paragraph. Generally speaking, a “hash function” is any function that has a mapping of an input to a number (i.e., hash value). Thus, in various embodiments, specific hashing algorithms such as an MD5 hash, a SHA-1 hash, etc may be used. In the illustrated example, the input to the hash function may include the characters forming the paragraph or values representing the characters such as the ASCII ordinal values of the characters or the alphabetic character positions of the characters within each paragraph. Characters such as punctuation symbols, and/or numbers may or may not be included as input to the hash function, depending upon the embodiment.

It is also noted that in some embodiments, multiple hash values may be generated for each paragraph using different hash functions. In addition, it is noted that in some alternative embodiments, hash values may be computed for character sequences other than paragraphs, such as, for example, sentences, portions of paragraphs, or any other variations for grouping characters.

In step 230, each paragraph in each email document within email database 120 is identified as being a common-type or uncommon-type paragraph. As used herein, a paragraph is identified as a common-type or uncommon-type paragraph based on the frequency that it appears in other email documents (i.e. the number of times a paragraph appears in other email documents). In one embodiment, this identification may be based on a threshold level, where a paragraph is identified as a common-type paragraph if it appears in enough email documents to exceed this threshold level and is identified as an uncommon-type paragraph if it does not. In some embodiments, this threshold level may be predetermined or specified by user input. In various embodiments, this identification may be based on the hash values of the respective paragraphs being evaluated. In the illustrated embodiment of FIG. 3, a paragraph is identified as being a common-type paragraph if it appears in more than one email document, and a paragraph is identified as being an uncommon-type paragraph if it appears in only one email document. For example, when analyzing the email documents 301A and 301B in email database 120, the paragraph “The quick brown fox jumped over the lazy dog” is identified as a common-type paragraph since it appears in both email documents 301A and 301B. On the other hand, the paragraph “The dog was sleeping” is identified as an uncommon-type paragraph since it only appears within the email document 301B. It is noted that while this example identifies a paragraph as common-type if it occurs in more than one email document, in typical implementations, this threshold value may be significantly larger. It is also noted that while the identification of each paragraph is based the email documents contained in database 120 (e.g., email documents 301A and B), in various other embodiments, this identification may be based on a frequency that includes whether the particular email document to be evaluated contains the paragraph. It is also noted that the terms “common-type” and “uncommon-type” may be applied to other subsets of character sequences besides paragraphs (e.g., sentences, portions of paragraphs, etc.).

In step 240, each of the email documents is grouped into either a first or second set with other email documents based on the identifications of each of its paragraphs. For example, if an email document contains only common-type paragraphs, then it may be associated with a first set of email documents that only contain common-type paragraphs. On the other hand, if an email document contains at least one uncommon-type paragraph, it may be associated with a second set of email documents that contain one or more uncommon-type paragraphs. In the illustrated embodiment of FIG. 3, email document 301A contains only a common-type paragraph “The quick brown fox jumped over the lazy dog” so it is associated with the first group of email documents. In contrast, email document 301B contains at least one uncommon-type paragraph “The dog was sleeping” so it is associated with the second group of email documents. It is noted that while in this embodiment only two email document groupings are described in other embodiments more groups may be generated based on different criteria (e.g., multiple different threshold levels).

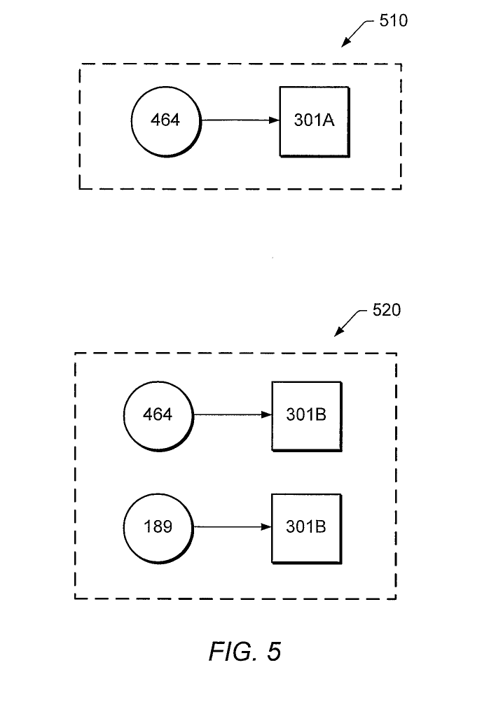

In steps 250A and 250B, the paragraphs of each of the email documents are included in a first or second searchable group based on the groupings generated in step 240. In one particular embodiment depicted in FIG. 5, searchable group 510 represents the set of email documents that contain only common-type paragraphs, and searchable group 520 represents the set of email documents that contain at least one uncommon-type paragraph. That is, since email document 301A contains only common-type paragraphs, searchable group 510 contains a mapping for the paragraph “The quick brown fox jumped over the lazy dog” represented by hash value “464” to email document 301A. Similarly, since email document 301B contains at least one uncommon-type paragraph, searchable group 520 contains two mappings for each of the paragraphs represented by hash values “189” “464” to email document 301B. In general, a searchable group is any data structure that associates paragraphs to one or more email documents that contain the paragraphs. As shown, in some embodiments, a searchable group may associate the hash value of each paragraph to one or more corresponding email documents.

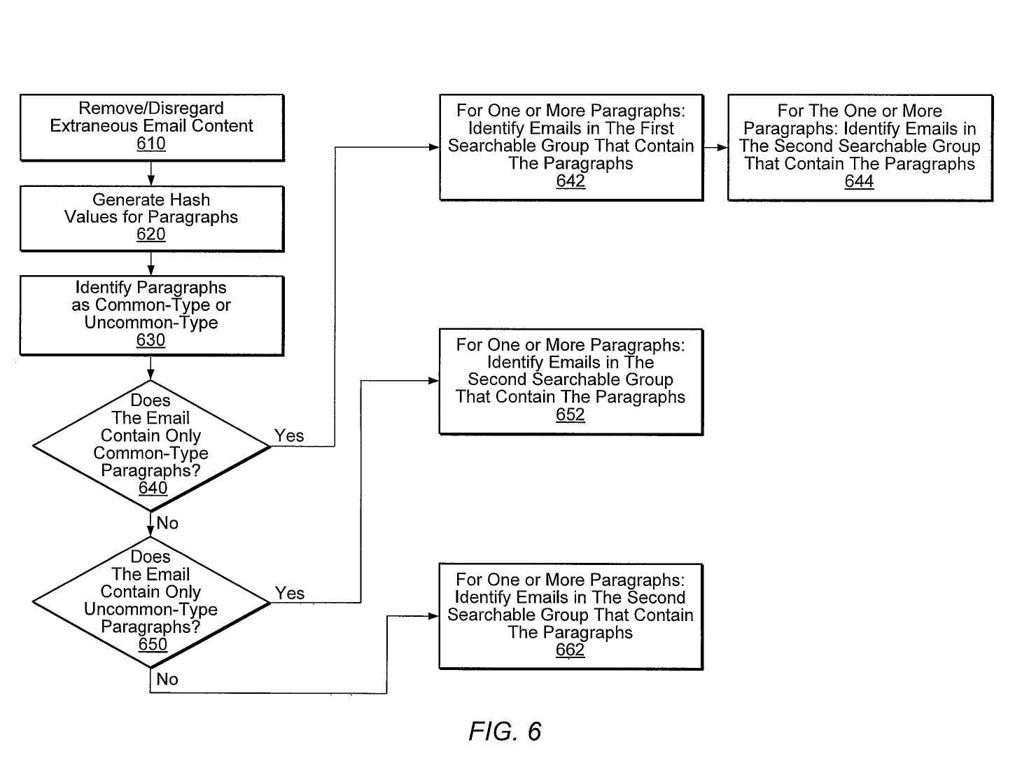

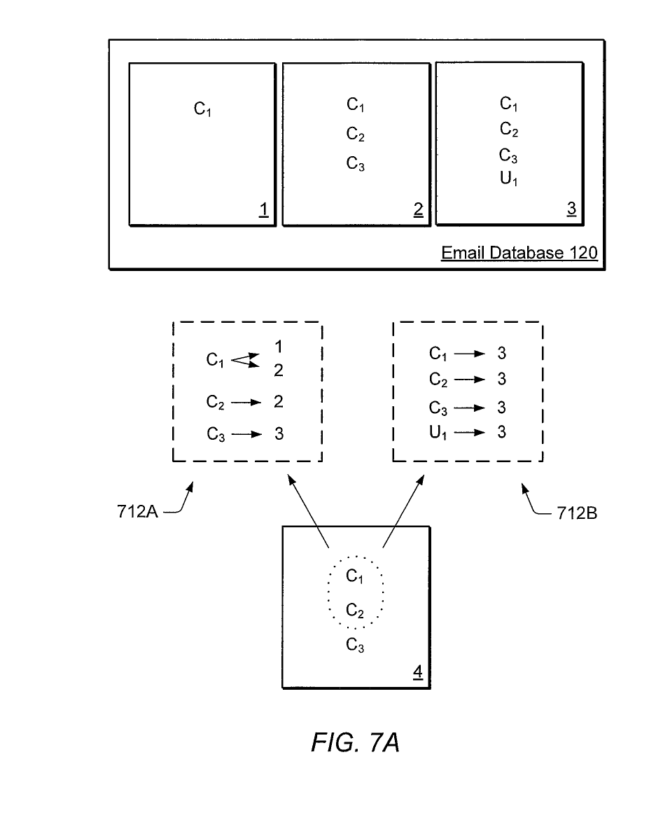

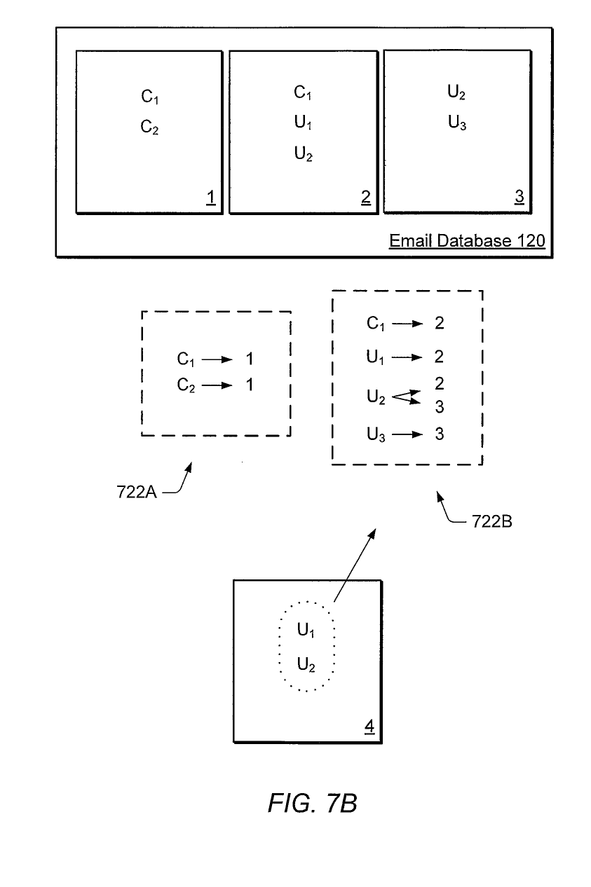

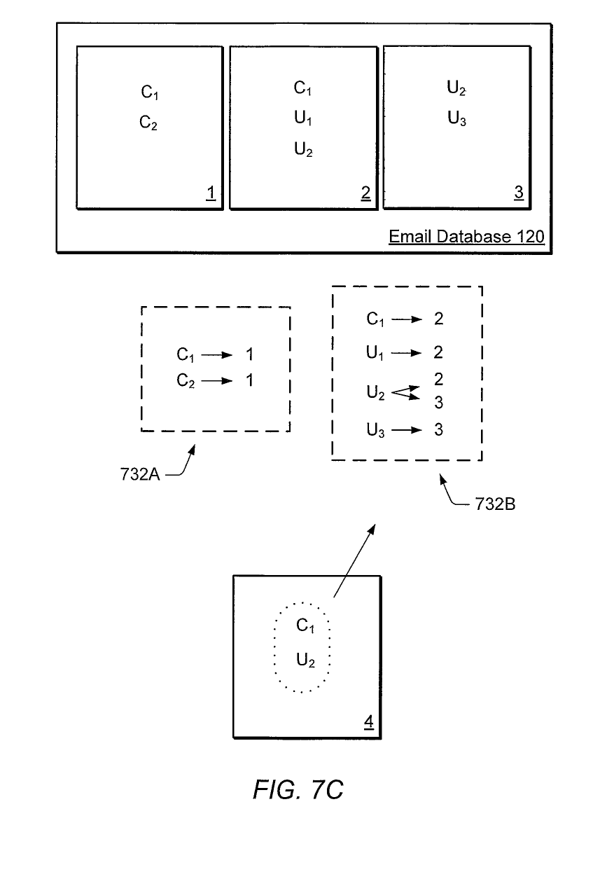

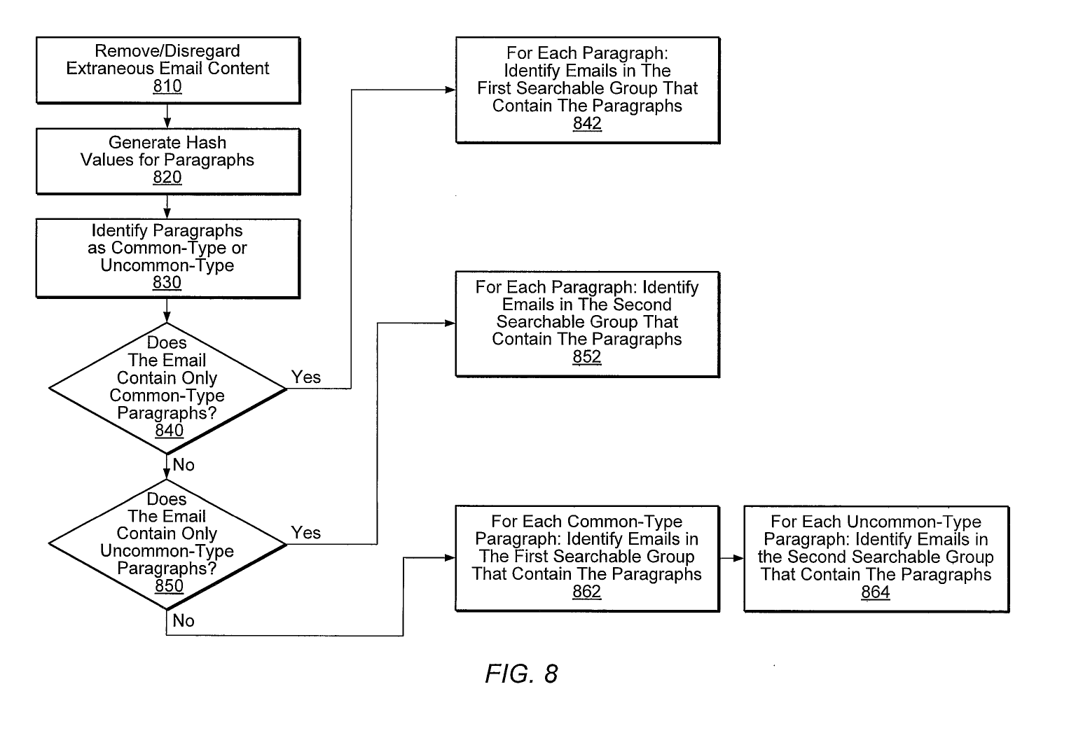

Once searchable groups have been generated from the email documents in email database 120, each of the paragraphs of a particular email may be searched for in one or both of the searchable groups to determine whether the content of the particular email document contains or is contained within other email documents. FIG. 6 is one embodiment of a flow diagram that selectively searches either one or both searchable groups depending upon whether the particular email contains only common-type paragraphs, only uncommon-type paragraphs, or a combination of common-type and uncommon-type paragraphs, and identifies one or more email documents that contain the content of a particular email document. While the operations of FIG. 6 are shown in a particular order, certain operations may be performed in parallel or in various other orders. For example, steps 620 and 630 may be performed in a different order than illustrated. In addition, in some embodiments, various operations (such as those of step 610) may be omitted. Operations illustrated by FIG. 6 will be discussed in conjunction with exemplary situations illustrated by FIGS. 7A-C.

In step 610, extraneous email content in a particular email document being processed is removed or disregarded. Step 610 may be performed using the same or similar techniques described above in step 210. For example, header information may be removed from the particular email document.

In step 620, a set of hash values is generated from the content of the particular email document. Step 620 may be performed using the same or similar techniques described above in step 220. Thus, a hash value may be generated for each paragraph in the particular email document.

In step 630, each paragraph in the particular email document to be evaluated is identified as being a common-type or uncommon-type paragraph. Step 630 may be performed using the same or similar techniques described above in step 230. Thus, in some embodiments, the identification of each paragraph may be based on the frequency that it appears in other email documents.

In step 640, if the particular email document contains only common-type paragraphs, both the first and second searchable groups, generated in steps 250A and 250B respectively, are searched. In step 642, email documents in the first group are identified if they contain the searched paragraphs of the particular email document. In step 644, email documents in the second group are identified if they contain the searched paragraphs of the particular email document.

FIG. 7A illustrates an example where an email document 4, which contains only common-type paragraphs C₁, C₂, and C₃, is evaluated. As shown, email database 120 contains at least three email documents 1, 2, and 3 that contain common-type paragraphs C₁, C₂, and C₃ and uncommon-type paragraph U₁. A searchable group 712A is generated from the paragraphs of email documents 1 and 2, since both emails contain only common-type paragraphs C₁₋₃. As describe above in relation to FIG. 5, each searchable group has a mapping for each paragraph to the corresponding emails that contains it. For example, since email documents 1 and 2 contain paragraph C₁, a mapping of C₁ to email documents 1 and 2 is shown. A searchable group 712B is generated in a similar manner from the paragraphs of email document 3, since it contains at least one uncommon-type paragraph U₁.

When email document 4 is evaluated, both searchable groups 712A and 712B are searched. In step 642, searchable group 712A is searched with paragraphs C₁ and C₂ of email document 4, and email document 2 is identified as potentially containing content of email document 4, since it contains both paragraphs. Alternatively, email document 1 is not identified because it only contains paragraph C₁. In step 644, searchable group 712B is searched with paragraphs C₁ and C₂, and email document 3 is identified as potentially containing content of email document 4, since it also contains both paragraphs.

It is noted that in this example, only two of the paragraphs of email document 4 are searched for (e.g., C₁ and C₂, but not C₃). Since the operations illustrated by FIG. 6 identify potential email documents that contain content of a particular email, not all of the paragraphs must be searched for. Accordingly, in various embodiments, more or less paragraphs may be searched for.

In step 650, if the particular email document contains only uncommon-type paragraphs, the second searchable group, generated in step 250B, is searched. In step 652, email documents in the second group are identified if they contain the searched paragraphs of the particular email document.

FIG. 7B illustrates an example where an email document 4, which contains only uncommon-type paragraphs U₁ and U₂, is evaluated. As shown, email database 120 contains at least three email documents 1, 2, and 3 that contain common-type paragraphs C₁ and C₂ and uncommon-type paragraphs U₁, U₂, and U₃. A searchable group 722A is generated from the paragraphs C₁₋₂ of email document 1, and a searchable group 722B is generated in a similar manner from the paragraphs C₁, U₁, U₂, and U₃ contained within email documents 2 and 3.

When email document 4 is evaluated, only searchable group 722B is searched. In step 652, searchable group 722B is searched with paragraphs U₁ and U₂, and email document 2 is identified as potentially containing content of email document 4, since it contains both paragraphs, while email document 3 is not identified, because it does not.

In step 650, if the particular email document contains a combination of common-type and uncommon-type paragraphs, the second searchable group, generated in step 250B, is searched. In step 662, email documents in the second group are identified if they contain the searched paragraphs of the particular email document.

FIG. 7C illustrates an example where an email document 4, which contains both a common-type paragraph C₁ and an uncommon-type paragraph U₂, is evaluated. As shown, email database 120 contains at least three email documents 1, 2, and 3 that contain common-type paragraphs C₁ and C₂ and uncommon-type paragraphs U₁, U₂, and U₃. A searchable group 732A is generated from the paragraphs C₁ and C₂ of email document 1, and a searchable group 732B is generated in a similar manner from the paragraphs C₁, U₁, U₂, and U₃ contained within email documents 2 and 3.

When email document 4 is evaluated, only searchable group 732B is searched. In step 662, searchable group 732B is searched with paragraphs C₁ and U₂, and email document 2 is identified as potentially containing content of email document 4, since it contains both paragraphs.

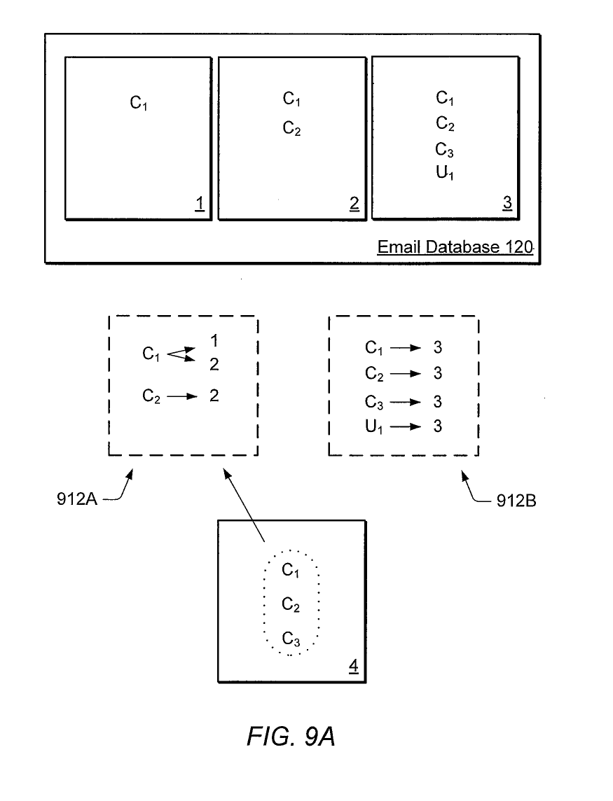

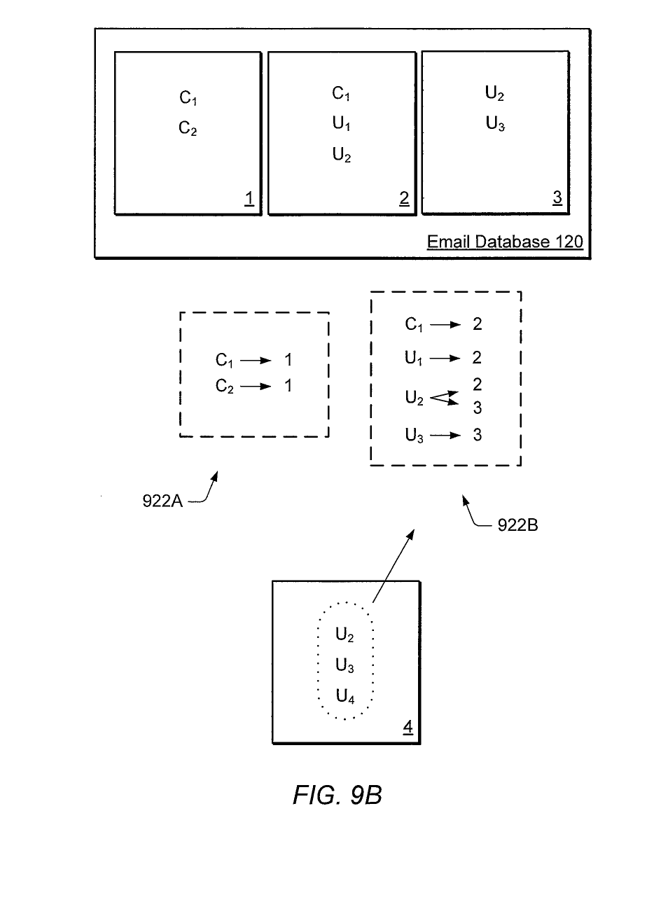

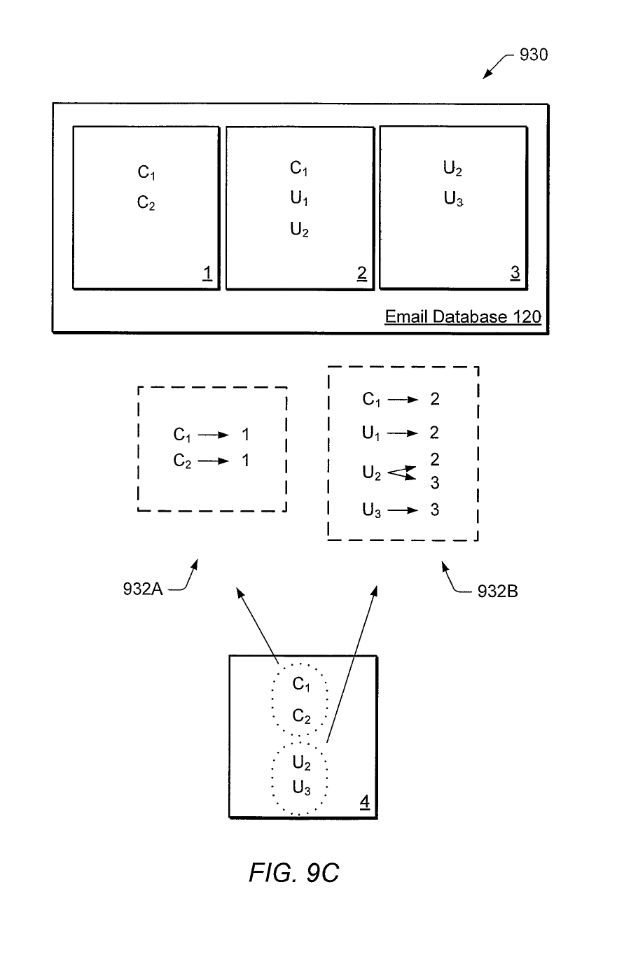

FIG. 8 is one embodiment of a flow diagram that selectively searches either one or both of the searchable groups depending upon whether the particular email contains only common-type paragraphs, only uncommon-type paragraphs, or a combination of common-type and uncommon-type paragraphs, and identifies each email document that may be contained within the particular email. While the operations of FIG. 8 are shown in a particular order, certain operations may be performed in parallel or in various other orders. For example, steps 820 and 830 may be performed in a different order than illustrated. In addition, in some embodiments, various operations (such as those of step 810) may be omitted. Operations illustrated by FIG. 8 will be discussed in conjunction with exemplary situations illustrated by FIGS. 9A-C.

In step 810, extraneous email content in the particular email document being processed is removed or disregarded. Step 810 may be performed using the same or similar techniques described above in step 210. For example, header information may be removed from the particular email document.

In step 820, a set of hash values is generated from the content of the particular email document. Step 820 may be performed using the same or similar techniques described above in step 220. Thus, a hash value may be generated for each paragraph in the particular email document.

In step 830, each paragraph in the particular email document is identified as being a common-type or uncommon-type paragraph. Step 830 may be performed using the same or similar techniques described above in step 230. Thus, in various embodiments, the identification of each paragraph may be based on the frequency that it appears in other email documents.

In step 840, if the particular email document contains only common-type paragraphs, only the first searchable group, generated in step 250A, is searched. In step 842, each email document in the first group is identified if it is potentially contained within the particular email document.

FIG. 9A illustrates an example where an email document 4, which contains only common-type paragraphs C₁, C₂, and C₃, is evaluated. As shown, email database 120 contains at least three email documents 1, 2, and 3 that contain common-type paragraphs C₁, C₂, and C₃ and uncommon-type paragraph U₁. A searchable group 912A is generated from the paragraphs C₁ and C₂ of email documents 1 and 2, since both emails contain only common-type paragraphs. A searchable group 912B is generated in a similar manner from the paragraphs C₁, C₂, C₃, and U₁ of email document 3, since it contains at least one uncommon-type paragraph U₁.

When email document 4 is evaluated, only searchable groups 912A is searched. In step 842, searchable group 912A is searched with each paragraph C₁, C₂, and C₃ of email document 4, and email documents 1 and 2 are identified, since both emails contain at least one of the searched paragraphs. Thus, the contents of email documents 1 and 2 may be contained within email document 4.

It is noted that in this example, all paragraphs of email document 4 are searched for. Since the operations illustrated by FIG. 8 identify each email document that may be contained within the particular email document, all of the paragraphs are searched for (as apposing to the operations of FIG. 6, where one or more of the paragraphs are searched for).

In step 850, if the particular email document contains only uncommon-type paragraphs, the second searchable group, generated in step 250B, is searched. In step 852, each email document in the second group is identified if it is potentially contained within the particular email document.

FIG. 9B illustrates an example where an email document 4, which contains only uncommon-type paragraphs U₂, U₃, and U₄, is evaluated. As shown, email database 120 contains at least three email documents 1, 2, and 3 that contain common-type paragraphs C₁ and C₂ and uncommon-type paragraphs U₁, U₂, and U₃. A searchable group 922A is generated from the paragraphs C₁₋₂ of email document 1, and a searchable group 922B is generated in a similar manner from the paragraphs C₁, U₁, U₂, and U₃ contained within email documents 2 and 3.

When email document 4 is evaluated, only searchable group 922B is searched. In step 852, searchable group 922B is searched with paragraphs U₂, U₃, and U₄, and email documents 2 and 3 are identified, since both emails contain at least one of the searched paragraphs. Thus, the contents of email documents 2 and 3 may be contained within email document 4. It is noted that in this illustrated embodiment, email document 2 is identified, even though email document 2 contains paragraphs C1 and U1, which are not contained within email document 4. In various embodiments, email document 2 may not be identified if different identification criteria are used (e.g., an email document is identified when two or more searched paragraphs are found within the email document).

In step 850, if the particular email document contains a combination of common-type and uncommon-type paragraphs, both the first and second searchable groups, generated in steps 250A and 250B respectively, are searched. In step 862, each email document in the first group is identified if it contains one or more common-type paragraphs of the particular email document. In step 864, each email document in the second group is identified if it contains one or more uncommon-type paragraphs of the particular email document.

FIG. 9C illustrates an example where an email document 4, which contains both common-type paragraphs C₁ and C₂ and uncommon-type paragraphs U₂ and U₃, is evaluated. As shown, email database 120 contains at least three email documents 1, 2, and 3 that contain common-type paragraphs C₁ and C₂ and uncommon-type paragraphs U₁, U₂, and U₃. A searchable group 932A is generated from the paragraphs C₁ and C₂ of email document 1, and a searchable group 932B is generated in a similar manner from the paragraphs C₁, U₁, U₂, and U₃ contained within email documents 2 and 3.

When email document 4 is evaluated, both searchable groups 932A and 932B are searched. In step 862, searchable group 932A is searched with the common-type paragraphs C1 and C2, and email documents 1 is identified, since it contains at least one of the common-type paragraphs. In step 864, searchable group 932B is searched with the uncommon-type paragraphs U2 and U3, and email documents 2 and 3 are identified since they contain at least one of the uncommon-type paragraphs.

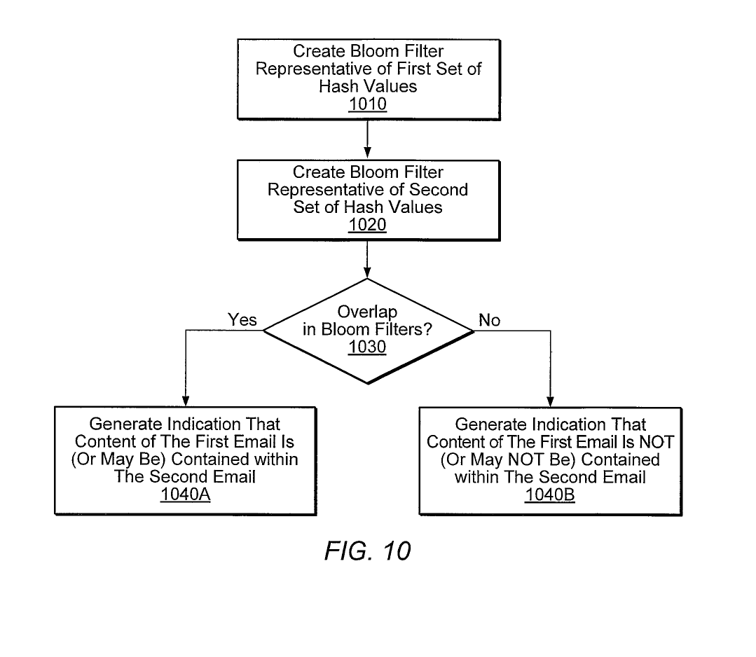

As mentioned above, if containment detection code 130 has identified one or more email documents that may contain or be contained within a particular email document, containment detection code 130 may further evaluate identified email documents to determine and/or verify the extent to which content of one email is contained within another. In one such embodiment, this evaluation may include comparing hash values of identified emails to determine whether one set of hash values forms a smaller subset of another set (thus, indicating that content of one email is contained within another). FIG. 10 is a flowchart of one embodiment of a method for comparing hash values using bloom-filtering techniques. Further details describing such an implementation are disclosed in U.S. patent application Ser. No. 12/059,176, which is incorporated herein in its entirety.

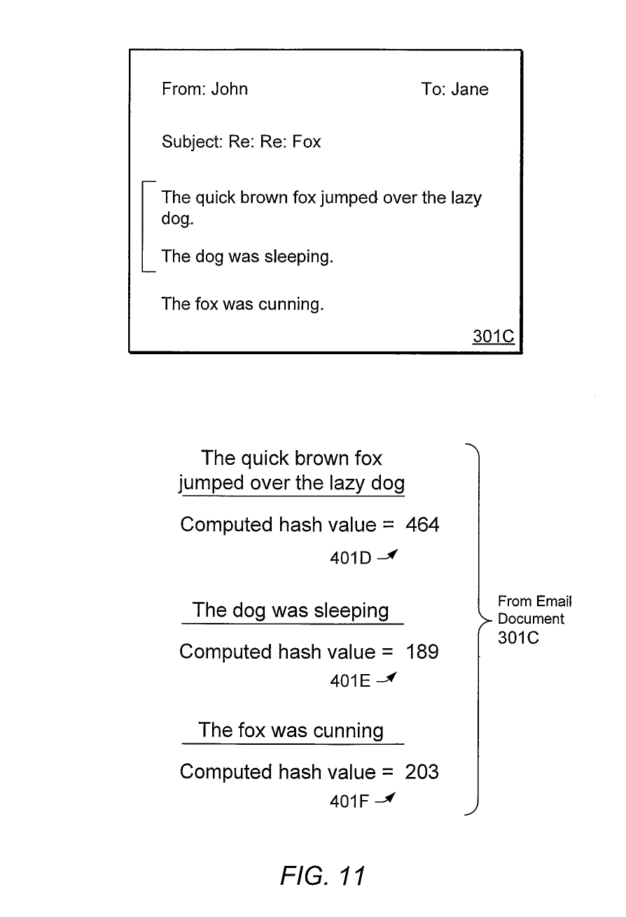

Operations of FIG. 10 will be described in conjunction with an exemplary situation using email document 301B, shown in FIG. 3, and email document 301C, shown in FIG. 11. Email document 301C represents a possible email document that may be identified by the operations of FIG. 6 or FIG. 8, describe above. As shown in FIG. 11, a set of hash values (e.g., hash values 401D-F) may be generated from each the paragraphs in email document 301C in step 620 or step 820. In this example, email document 301C is an email document that is further being evaluated to determine whether its content contains email documents 301A and 301B. Email document 301C represents a possible response to email document 301B and contains the sequence “The fox was cunning,” which is not included in either email documents 301A or 301B. In one embodiment, email document 301C may already be contained within database 120. In another embodiment, email document 301C may be received and evaluated in real-time.

In the step 1010, a first set of hash values generated from each paragraph in a first email document is reflected in a bloom filter. Generally speaking, a “bloom filter” is a data structure in the form of a bit vector that represents a set of elements and is used to test if an element is a member of the set. Initially, an empty bloom filter may be characterized as a bit array of zeros. As elements are added to the bloom filter, corresponding, representative bits may be set.

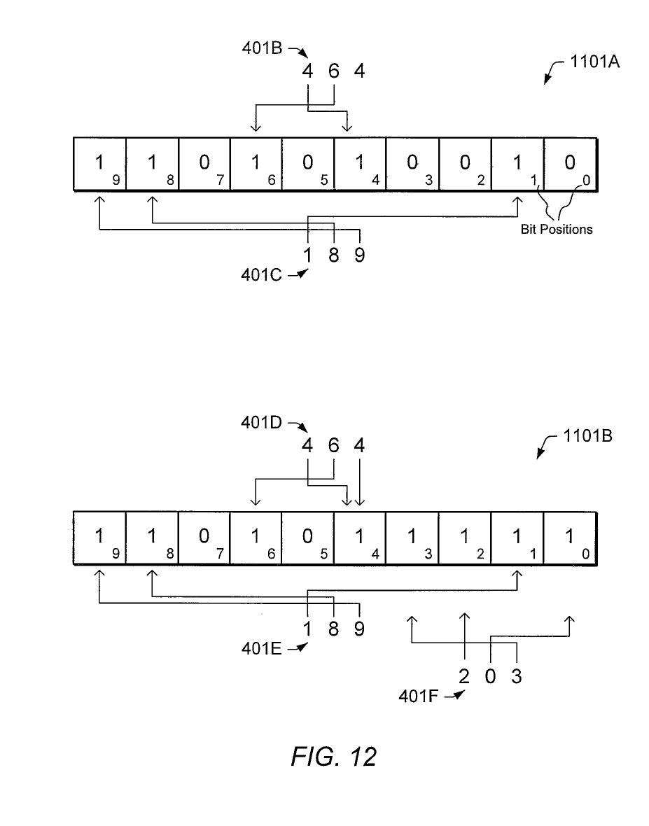

Thus, as illustrated in FIG. 12, the computed hash values 401B of “464” and 401C of “189” corresponding to the paragraphs from email document 301B are reflected in bloom filter 1101A by setting selected bits. In particular, for the specific bloom-filtering algorithm illustrated in this example, bit positions 4 and 6 of bloom filter 1101A are set based on the digits forming the computed hash value “464”, and bits corresponding to positions 1, 8, and 9 are similarly set for hash value “189”. In step 1020, as shown, the computed hash values, corresponding to the paragraphs from the second email document 301C, are reflected in bloom filter 1101B by similarly setting selected bits.

It is noted that any variety of other bloom-filtering algorithms may be employed in other embodiments. For example, the size of the vector (i.e. number of bits) forming the bloom filter data structure may be significantly larger than that illustrated in FIG. 12, and a given hash value may be represented in the bloom filter by setting other specific bit positions, as dictated by the algorithm.

In step 1030, the bloom filters generated in steps 1010 and 1020 are compared to determine an extent of overlap. As shown in FIG. 11, the computed hash values “464” and “189” are represented in both bloom filters 1101A and 1101B, and thus, bits at positions 1, 4, 6, 8 and 9 in bloom filters 1101A and 1101B are correspondingly set. On the other hand, hash value “203” is only represented in bloom filter 1101B, and thus, bits at positions 2, 0, and 3 are not correspondingly set in bloom filter 1101A.

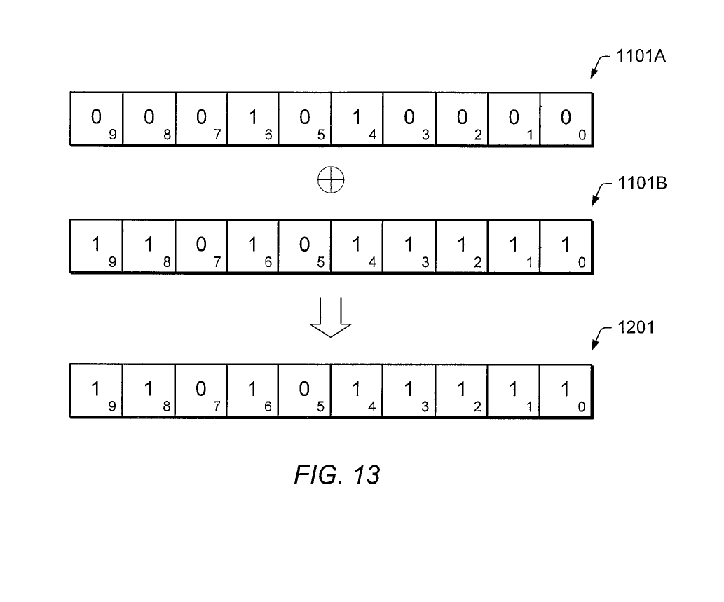

In one particular embodiment depicted in FIG. 13, a bitwise OR may be performed to compare the bloom filters of two email documents. In this example, bit vector 1201 is generated from the bitwise OR between the bit vectors of bloom filters 1101A and 1101B, and is subsequently compared with each of the bloom filters 1101A and 1101B. If the resultant bit vector 1201 of the bitwise OR matches either of the input bloom filters 1101A or 1101B, containment detection code 130 may provide an indication that the content of one email is contained (or potentially contained) within the content of the other email in step 1040A. Conversely, if the resultant bit vector 1201 of the bitwise operation does not match either of bloom filters 1101A and 1101B, containment detection code 130 may provide an indication that the content of either email is not contained (or possibly not contained) within the other in step 1040B. In the particular example illustrated by FIG. 12, it is noted that bit vector 1201 does match bloom filter 1101B, and thus, containment detection code 130 provides an indication that the content of email document 301B is contained within the content of email document 301C.

Although specific embodiments have been described above, these embodiments are not intended to limit the scope of the present disclosure, even where only a single embodiment is described with respect to a particular feature. Examples of features provided in the disclosure are intended to be illustrative rather than restrictive unless stated otherwise. The above description is intended to cover such alternatives, modifications, and equivalents as would be apparent to a person skilled in the art having the benefit of this disclosure. The scope of the present disclosure includes any feature or combination of features disclosed herein (either explicitly or implicitly), or any generalization thereof, whether or not it mitigates any or all of the problems addressed by various described embodiments. Accordingly, new claims may be formulated during prosecution of this application (or an application claiming priority thereto) to any such combination of features. In particular, with reference to the appended claims, features from dependent claims may be combined with those of the independent claims and features from respective independent claims may be combined in any appropriate manner and not merely in the specific combinations enumerated in the appended claims.

What is claimed is:

1. A method, comprising:
identifying, for each email document of a plurality of email documents, whether each subset of one or more subsets of character sequences within the email document is a common-type subset of character sequences or an uncommon-type subset of character sequences;
grouping a first set of the plurality of email documents with only common-type subsets of character sequences in a first searchable group;
grouping a second set of the plurality of email documents with one or more uncommon-type subsets of character sequences in a second searchable group;
identifying whether each subset of character sequences in a particular email document to be evaluated is a common-type or an uncommon-type subset of character sequences;
selectively searching either only one of or both of the first and second searchable groups depending upon whether the particular email contains only common-type subsets of character sequences, only uncommon-type subsets of character sequences, or a combination of common-type and uncommon-type subsets of character sequences; and
identifying selected one or more email documents of the plurality of email documents that may contain content that is similar to the particular email document based on the searching.

2. The method of claim 1, wherein each subset of character sequences is a paragraph.

3. The method of claim 1, wherein the searching is both the first and second searchable groups if the particular email document contains only common-type subsets of character sequences, and wherein the searching is only the second searchable group if the particular email document contains only uncommon-type subsets of character sequences or a combination of common-type and uncommon-type subsets of character sequences.

4. The method of claim 1, wherein the searching is only the first searchable group if the particular email document contains only common-type subsets of character sequences, wherein the searching is only the second searchable group if the particular email document contains only uncommon-type subsets of character sequences, and wherein the searching is both the first and second group if the particular email document contains a combination of common-type and uncommon-type subsets of character sequences.

5. The method of claim 1, further comprising:
generating a first set of hash values corresponding to the particular email document, wherein the first set includes a respective hash value corresponding to each of the subsets of character sequences of the particular email document;
generating a second set of hash values corresponding to one of the identified, selected one or more email documents, wherein the second set includes a respective hash value corresponding to each of the subsets of character sequences of the identified, selected email document; and
comparing the first set of hash values with the second set of hash values.

6. The method claim 5, wherein one or more of the hash values of the first and second sets are generated using an MD5 or SHA-1 hashing algorithm.

7. The method of claim 5, further comprising:
generating a first bloom filter representing the first set of hash values corresponding to the particular email document;
generating a second bloom filter representing the second set of hash values corresponding to the identified, selected email document; and
wherein the comparing includes comparing the first bloom filter with the second bloom filter.

8. A computer readable medium storing program instructions that are computer executable to:
identify, for each email document of a plurality of email documents, whether each subset of one or more subsets of character sequences within the email document is a common-type subset of character sequences or an uncommon-type subset of character sequences;
group a first set of the plurality of email documents with only common-type subsets of character sequences in a first searchable group;
group a second set of the plurality of email documents with one or more uncommon-type subsets of character sequences in a second searchable group;
identify whether each subset of character sequences in a particular email document to be evaluated is a common-type or an uncommon-type subset of character sequences;
selectively search either only one of or both of the first and second searchable groups depending upon whether the particular email contains only common-type subsets of character sequences, only uncommon-type subsets of character sequences, or a combination of common-type and uncommon-type subsets of character sequences; and
identify selected one or more email documents of the plurality of email documents that may contain content that is similar to the particular email document based on the search.

9. The computer readable medium of claim 9, wherein each subset of character sequences is a paragraph.

10. The computer readable medium of claim 9, wherein the program instructions are executable to search only the second searchable group if the particular email document contains at least one uncommon-type subset of character sequences.

11. The computer readable medium of claim 9, wherein the program instructions are executable to search either only the first searchable group or both the first and second searchable groups if the particular email document contains only common-type subsets of character sequences.

12. The computer readable medium of claim 9, wherein the program instructions are executable to search both the first and second searchable groups if the particular email contains a combination of common-type and uncommon-type subsets of character sequences, and the program instructions are further executable to search the first searchable group using the common-type subsets of character sequences in the particular email document and the second searchable group using the uncommon-type subsets of character sequences in the particular email document.

13. The computer readable medium of claim 9, wherein the program instructions are further executable to disregard predetermined content of each email document in the plurality of email documents, prior to identifying whether each subset of character sequences within the email document is a common-type subset of character sequences or an uncommon-type subset of character sequences.

14. The computer readable medium of claim 13, wherein the predetermined content includes email header information.

15. A system, comprising:
one or more processors;
a memory storing program instructions that are computer-executable by the one or more processors to:
identify, for each email document of a plurality of email documents, whether each subset of one or more subsets of character sequences within the email document is a common-type subset of character sequences or an uncommon-type subset of character sequences;
group a first set of the plurality of email documents with only common-type subsets of character sequences in a first searchable group;
group a second set of the plurality of email documents with one or more uncommon-type subsets of character sequences in a second searchable group;
identify whether each subset of character sequences in a particular email document to be evaluated is a common-type or an uncommon-type subset of character sequences;
selectively search either only one of or both of the first and second searchable groups depending upon whether the particular email contains only common-type subsets of character sequences, only uncommon-type subsets of character sequences, or a combination of common-type and uncommon-type subsets of character sequences; and
identify selected one or more email documents of the plurality of email documents that may contain content that is similar to the particular email document based on the search.

16. The system of claim 15, wherein each subset of character sequences is a paragraph.

17. The system of claim 15, wherein the program instructions are executable to search both the first and second searchable groups if the particular email document contains only common-type subsets of character sequences, and search only the second searchable group if the particular email document contains only uncommon-type subsets of character sequences or a combination of common-type and uncommon-type subsets of character sequences.

18. The system of claim 15, wherein the program instructions are executable to search only the first searchable group if the particular email document contains only common-type subsets of character sequences, search only the second searchable group if the particular email document contains only uncommon-type subsets of character sequences, and search both the first and second group if the particular email contains a combination of common-type and uncommon-type subsets of character sequences.

19. The system of claim 15, wherein program instructions are further executable to:
generate a first bloom filter representing the subsets of character sequences corresponding to the particular email document;
generate a second bloom filter representing the subsets of character sequences corresponding to one of the identified, selected one or more email documents; and
compare the first bloom filter with the second bloom filter.

20. The system of claim 19, wherein the program instructions are executable to compare the first bloom filter with the second bloom filter by performing a bitwise OR operation.
